(19) United States
(12) Patent Application Publication
(10) Pub. No.: US 2012/0069206 A1
(43) Pub. Date: Mar. 22, 2012

(54) CAMERA IMAGE CORRECTION SYSTEM AND IMAGE CORRECTION METHOD EMPLOYING THE SAME

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/942,171

(22) Filed: Nov. 9, 2010

(30) Foreign Application Priority Data
Sep. 16, 2010 (TW) 99131524

(51) Int. Cl. H04N 5/232

(52) U.S. Cl. 348/211.2; 348/E05.043

(57) ABSTRACT

A camera image correction system includes an image correction device and an internet protocol camera intercommunicating with the image correction device. The image correction device includes an input module, a signal processing module, and a wireless communications module. The input module inputs and generates correction instructions that the signal processing module processes. The wireless communications module transmits the correction images to the internet protocol camera. The internet protocol camera includes an antenna, a system on chip, and a signal control module. The antenna receives the correction instruction; the signal control module processes the correction instructions to generate command signals. The system on chip controls the internet protocol camera according to the command signals to obtain monitoring images, the monitoring images are processed by the signal control module and transmitted to the image correction device through the antenna and the wireless communications module.

### BACKGROUND

1. Technical Field

The disclosure generally relates to camera image correction systems and correction methods, and more particularly relates to, an internet protocol (IP) camera image correction system and an image correction method used for correcting images.

2. Description of the Related Art

IP cameras are types of digital video cameras commonly employed for surveillance, and can send and receive data by a computer network and the internet. The IP cameras stream live video by digital packets across an internet protocol network such as a LAN (local area network) or the internet. The video streams can then be remotely accessed and stored.

However, to debug the IP camera, an internet terminal, such as a computer, is typically employed to display images of the IP camera, as to further adjust the shooting angles and installation location of the IP camera to obtain better shooting angles, image quality and surveillance. Thus, it's inconvenient for the user to repeatedly and continuously adjust and correct the shooting angles of the IP camera.

Therefore, there is room for improvement within the art.

### BRIEF DESCRIPTION OF THE DRAWINGS

Many aspects of an exemplary camera image correction system and image correction method employing the same can be better understood with reference to the following drawings. The components in the drawings are not necessarily drawn to scale, the emphasis instead being placed upon clearly illustrating the principles of the exemplary camera image correction system and image correction method employing the same. Moreover, in the drawings, like reference numerals designate corresponding parts throughout the several views. Wherever possible, the same reference numbers are used throughout the drawings to refer to the same or like elements of an embodiment.

FIG. 1 is a schematic view of a camera image correction system including an internet protocol camera and an image correction device, according to an exemplary embodiment.

FIG. 2 is a circuit view of the internet protocol camera and the image correction device as shown in FIG. 1.

FIG. 3 is a flow chart illustrating an image correction method, according to an exemplary embodiment.

### DETAILED DESCRIPTION

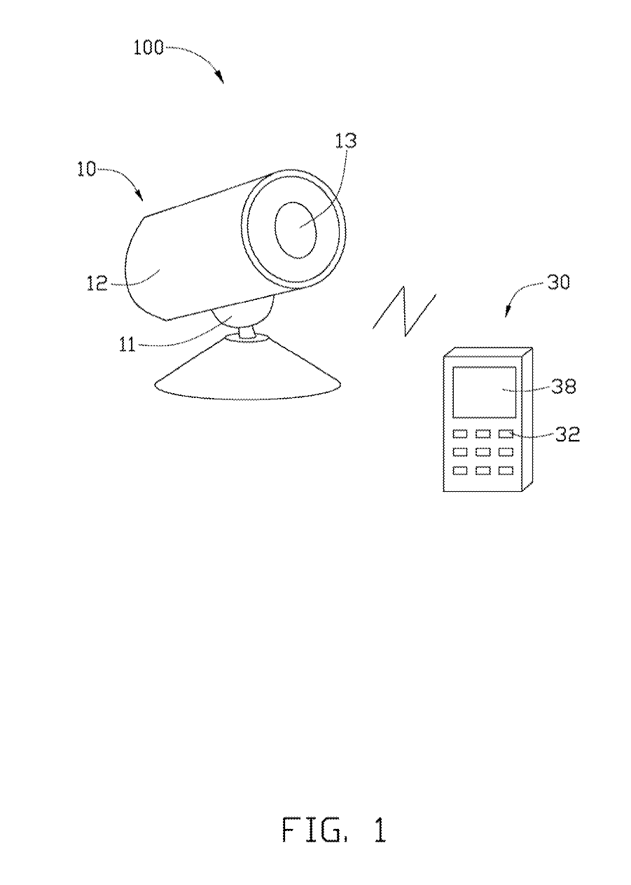

FIG. 1 shows a camera image correction system 100 according to an exemplary embodiment. The camera image correction system 100 includes an internet protocol (IP) camera 10 and an image correction device 30 intercommunicating with the IP camera 10.

The image correction device 30 can be a portable electronic device and is capable of providing a corresponding correction instruction to the IP camera 10, and the IP camera 10 is then controlled and adjusted according to the correction instruction, and then feeds back corresponding monitoring images to display on the image correction device 30 to obtain clear and suitable monitoring images.

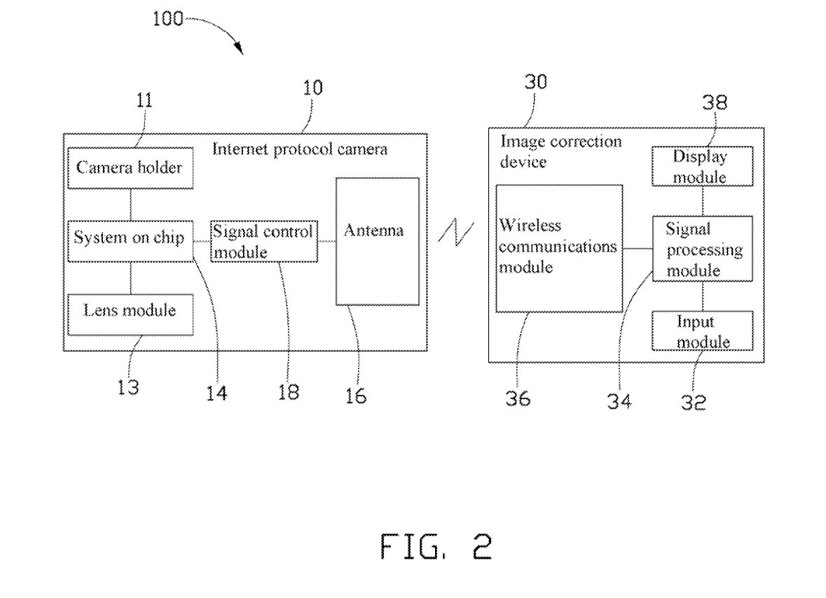

Also referring to FIG. 2, the IP camera 10 may be a PTZ (pan tilt zoom) IP camera which includes a camera holder 11, a housing 12, a lens module 13, a system on chip (SOC) 14, an Antenna 16, and a signal control module 18. The lens module 13, the SOC 14, the Antenna 16, and the signal control module 18 are received within the housing 12. The camera holder 11, the lens module 13, and the signal control module 18 are electrically connected to the SOC 14.

The camera holder 11 is capable of securing and supporting the housing 12 to make the housing 12 rotate in the horizontal and vertical directions, allowing the IP camera 10 for surveillance or monitoring from different angles. The lens module 13 is operable for obtaining and capturing image information within monitoring view of the IP camera 10. The SOC 14 is capable of reading and processing its different application programs to control the camera holder 11 to rotate in different directions (e.g., up and down, left and right) and automatically adjust the lens focal length of the lens module 13 according to the correction instruction. The SOC 14 can be integrated with different extended interfaces, such as memory extended interfaces, touch panel extended interfaces, and/or universal serial bus (USB) interfaces.

The antenna 16 is electrically connected to the signal control module 18 and is capable of receiving the correction instruction from the image correction device 30, and further transmitting the correction instruction to the signal control module 18. The antenna 16 may be BLUETOOTH or for communicating with any other wireless network/system. The signal control module 18 can be a micro controller unit (MCU) and electrically connected to the SOC 14 by USB or other similar connection methods. The signal control module 18 is operable for processing the correction instruction from the antenna 16 to a generating corresponding command signal, and sending the command signal the SOC 14. The SOC 14 accordingly drives the camera holder 11 and control to adjust the rotation directions of the lens module 13 according to the command signal to obtain images. The SOC 14 transmits images from the lens module 13 to the image correction device 30 by the antenna 16.

The image correction device 30 can be integrated with a mobile phone or a personal digital assistant (PDA), which can independently transmit correction instruction. The image correction device 30 includes an input module 32, a signal processing module 34, a wireless communications module 36, and a display module 38.

The input module 32 can be a touch panel, a virtual key board or a mechanical keypad, and is capable of inputting different correction instructions, such as zoom instructions, rotation instructions. The signal processing module 34 can be a MCU and is electrically connected to the input module 32, the wireless communications module 36 and the display module 38. The wireless communications module 36 can include an antenna and is capable of receiving images from the IP camera 10 and transmitting correction instructions to the IP camera 10.

The signal processing module 34 is capable of receiving and processing the correction instructions from the input module 32, and transmitting the processed correction instructions to the IP camera 10 by the wireless communications module 36. The signal processing module 34 is further capable of receiving and processing the images from the wireless communications module 36, and transmitting the processed images to the display module 38. The display module 38 displays the images to real-time monitor the lens module 13 of the IP camera 10.

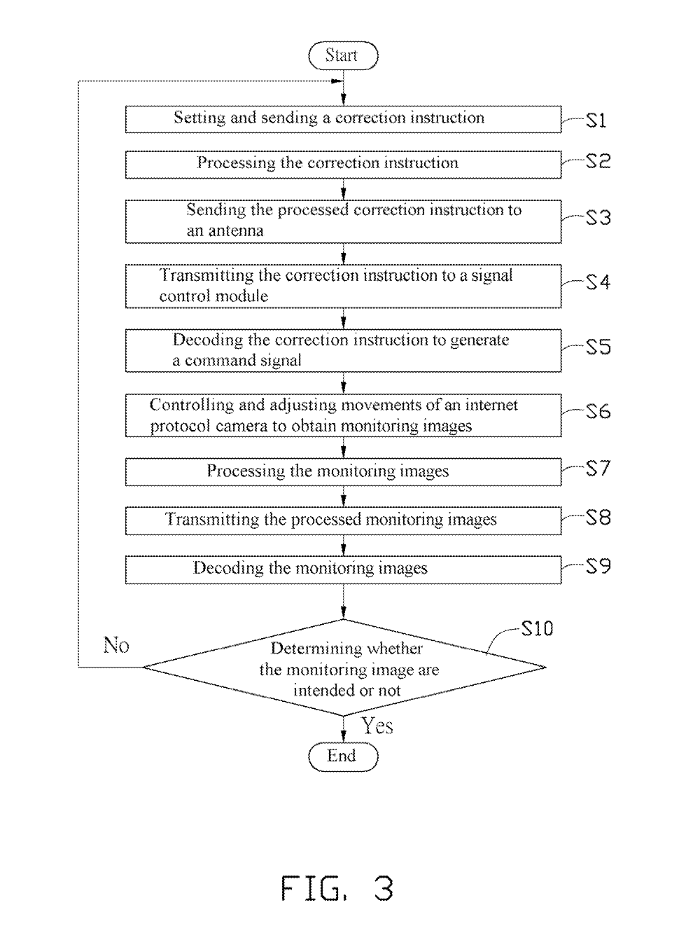

Further referring to FIG. 3, an image correction method according to an exemplary embodiment is depicted. The correction method can use the aforementioned camera image correction system 100 and may at least include the following steps.

In step S1, a correction instruction is set in the image correction device 30 using the input module 32 and is transmitted to the signal processing module 34.

In step S2, the correction instruction from the input module 32 is processed (e.g., encoding) by the signal processing module 34 and is transmitted to the wireless communications module 36.

In step S3, the correction instruction processed by the signal processing module 34 is transmitted from the wireless communications module 36 to the antenna 16 of the IP camera 10.

In step S4, the correction instruction received by the antenna 16 is transmitted to the signal control module 18.

In step S5, the correction instruction from the antenna 16 is processed (e.g., decoding) by the signal control module 18 to generate a corresponding command signal.

In step S6, the movements of the camera holder 11 and the lens module 13 are controlled and adjusted according to the command signal to obtain different monitoring images.

In step S7, different monitoring images provided by the lens module 13 are processed by the signal control module 18 and are transmitted to the antenna 16.

In step S8, the processed monitoring images are transmitted from the antenna 16 to the wireless communications module 36 of the image correction device 30.

In step S9, the monitoring images received by the wireless communications module 36 are processed (e.g., decoding) by the signal processing module 34 and are transmitted to the display module 38.

In step S10, the monitoring images are displayed on the display module 38 to determine whether the monitoring images are intended or not. If the monitoring images are unable to meet the intended requirement, step S1 is repeated.

In summary, in the camera image correction system 100 of the exemplary embodiment, the antenna 16 and the wireless communications module 36 are respectively mounted within the IP camera 10 and the image correction device 30. Thus, the IP camera 10 and the image correction device 30 can intercommunicate with each other to real-time monitor and adjust the shooting angles and surveillance images of the IP camera 10. Moreover, the IP camera 10 is easy to operate when installed and debugged, therefore can obtain better shooting angles, and image quality.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A camera image correction system, comprising:
an image correction device providing correction instructions, the image correction device comprising:
an input module for inputting and generating different correction instructions;
a signal processing module electrically connected to the input module, the signal processing module for processing the correction instructions from the input module; and
a wireless communications module electrically connected to the signal processing module, the wireless communications module for transmitting the corrections images; and
an internet protocol camera intercommunicating with the image correction device, the internet protocol camera comprising:
an antenna for receiving the correction instructions from the image correction device;
a signal control module electrically connected to the antenna, the signal control module for processing the correction instructions to generate corresponding command signals; and
a system on chip electrically connected to the signal control module, wherein the system on chip controls the movements of the internet protocol camera according to the command signals to obtain corresponding monitoring images, the monitoring images are processed by the signal control module and are transmitted to the image correction device through the antenna and the wireless communications module.

2. The camera image correction system as claimed in claim 1, wherein the wireless communications module comprises a BLUETOOTH module and the antenna comprises a BLUETOOTH antenna.

3. The camera image correction system as claimed in claim 1, wherein the signal processing module further receives and processes the monitoring images from the wireless communications module.

4. The camera image correction system as claimed in claim 3, wherein the image correction device further comprises a display module electrically connected to the signal processing module, the display module is capable of receiving and displaying the monitoring image to real-time control and monitor the internet protocol camera.

5. The camera image correction system as claimed in claim 1, wherein the internet protocol camera further comprises a lens module electrically connected to the system on chip, the lens module is capable of obtaining and capturing the monitoring images according to the command signals.

6. The camera image correction system as claimed in claim 5, wherein the internet protocol camera further comprises a housing, the lens module, the system on chip, the antenna, and the signal control module are received within the housing.

7. The camera image correction system as claimed in claim 6, wherein the internet protocol camera further comprises a camera holder, the camera holder is capable of securing and supporting the housing to make the housing rotate in different directions, allowing the internet protocol camera for surveillance or monitoring from different angles.

8. The camera image correction system as claimed in claim 1, wherein the input module is a touch panel, a virtual key board or a mechanical keypad.

9. The camera image correction system as claimed in claim 1, wherein the image correction device is integrated with a portable electronic device.

10. The camera image correction system as claimed in claim 1, wherein the system on chip is integrated with universal serial bus interfaces, and the system on chip is electrically connected to the signal control module through the universal serial bus.

11. An image correction method, comprising steps of:
transmitting a corresponding correction instruction from an image correction device to an internet protocol camera;
processing the correction instruction by a signal control module of the internet protocol camera to generate a corresponding command signal;
controlling the movements of the internet protocol camera according to the command signal to obtain monitoring images;
transmitting the monitoring images to the image correction device; and
displaying the monitoring images on the image correction device.

12. The image correction method as claimed in claim 11, further comprising setting the correction instruction by an input module of the image correction device.

13. The image correction method as claimed in claim 12, further comprising encoding the correction instruction from the input module by a signal processing module of the image correction device.

14. The image correction method as claimed in claim 11, further comprising transmitting the correction instruction to the signal control module.

15. The image correction method as claimed in claim 11, further comprising processing the monitoring images by the signal control module.

16. The image correction method as claimed in claim 11, further comprising decoding the monitoring images by a signal processing module of the image correction device to display.

17. The image correction method as claimed in claim 16, further comprising determining whether the displayed monitoring images are intended or not.

18. The image correction method as claimed in claim 17, wherein if the monitoring images are unable to meet the intended requirement, the step of setting the correction instruction by an input module of the image correction device is repeated.
